(19) United States
(12) Patent Application Publication
(10) Pub. No.: US 2026/0296316 A1
(43) Pub. Date: Oct. 1, 2026

(54) CAMERA-MONITOR SYSTEM FOR A VEHICLE

(71) Applicant: MEKRA Lang GmbH & Co. KG, Ergersheim (DE)

(72) Inventors: Andreas Enz, Burgbernheim (DE); Felix Bott, Markt Einersheim (DE); Lukas Baumann, Burgbernheim (DE)

(73) Assignee: MEKRA Lang GmbH & Co. KG, Ergersheim (DE)

(21) Appl. No.: 19/564,897

(22) Filed: Mar. 12, 2026

(30) Foreign Application Priority Data
Mar. 27, 2025 (DE) 102025112038.2

(51) Int. Cl. B60R 1/24; B60R 1/25; H04N 7/18; H04N 23/698

(52) U.S. Cl. CPC B60R 1/24; B60R 1/25; H04N 7/183; H04N 23/698; B60R 2300/10; B60R 2300/306; B60R 2300/60

(57) ABSTRACT

A camera-monitor system for a commercial vehicle to depict fields of view having a display unit in the driver cabin, a capturing unit having a single camera to capture image data comprising first, second, and third fields of view in front of the vehicle, a processing unit that processes the captured image data to depict them on the display unit and transmits them to the display unit. The first, second and third field of view have an extent in the longitudinal direction of the vehicle that exceeds 2 m, and the second and the third field of view each have an extent in lateral direction relative to the vehicle that exceeds 2 m.

### BACKGROUND OF THE INVENTION

### 1. Field of the Invention

The invention relates to a camera-monitor system for a vehicle, in particular, a commercial vehicle, with which fields of view surrounding the vehicle can be depicted on a display unit inside of the vehicle, such that a driver of the vehicle may view them. In particular, the invention relates to a camera-monitor system with which areas extending in front of the vehicle in the forward direction of travel perpendicular to the forward direction of travel of the vehicle can be depicted on the display unit.

### 2. Description of the Related Art

Camera-monitor systems on vehicles that are employed as an addition or a replacement for mirrors and that, in particular, make such areas visible to the driver that he cannot view by direct sight, are becoming more common in use. If the area captured and displayed by the camera-monitor system contains an area that, according to law, must be made visible to the driver by means of a device for indirect view, in particular, a mirror or a camera-monitor system, such a camera-monitor system is a mirror replacement system. In other cases, if mirrors are used for this purpose and the camera-monitor system captures additional areas to improve driving safety and/or to simplify perceiving the traffic situation for the driver, and/or to improve the comfort of the driver, it is a supplementary camera-monitor system.

One example for such supplementary camera-monitor systems are so-called cross traffic camera systems, which usually comprise one camera on each side of the vehicle that each are side-mounted in the front part of the vehicle, one on each side of the vehicle, respectively. These cameras are, in terms of their viewing direction, for the most part oriented to the side, i.e. for the most part perpendicular to the forward direction of travel of the vehicle. Areas are thus captured with the cameras, and displayed in the vehicle on a display unit, that lie to the side of the vehicle in front of the vehicle. Through this, the driver of the vehicle can, in particular if the vehicle has a large front end structure, view areas through the display unit that he does not yet see by direct sight early on, such as e.g., to be able to view cross traffic. Vehicles with a large front end structure are, in particular, commercial trucks with hoods, so-called conventional cab trucks, and vehicles, in particular, commercial vehicles, which comprise equipment mounted to the front of the vehicle, such as e.g. shovels or blades.

In the case of the known cross traffic cameras, the area lying in the forward direction of travel in front of the vehicle are either not captured using a camera at all, but the driver views these areas by direct sight. This, however, results in that the driver does not receive a continuous image of the traffic situation in front of and to the side of the vehicle, since he only sees the areas in front of the vehicle by direct sight, and only views the areas to the side of the vehicle on the display unit.

Thus, it has been suggested to mount an additional forward oriented camera (front camera) to the vehicle, such that both the area lying in front of the vehicle as well as the areas lying left and right to the side of the vehicle are captured by separate cameras, each oriented facing the respective direction, and are displayed on the display unit and, as appropriate, merged into one single image. This additional front camera as well as the use of two cameras for each of the areas lying left and right to the side of the vehicle, respectively, increase the complexity of the system and, thereby, the cost, and additionally lead to an increased vehicle weight.

The merging of multiple images into a single one image displayed on the display unit is described for camera-monitor systems, for example, in DE 10 2012 001 835 B4.

DE 10 2021 131 051 A1 relates to an image capturing system and an image capturing device that are capable of capturing an image of a three-dimensional object that is located in front of the vehicle at an angle. The system comprises multiple camera sensors for different areas around the vehicle. Among other things, a so-called Front-PVM is provided, comprising a fish-eye lens. With it, a frontal region of the vehicle is captured that also extends sideways in front of the vehicle. The Front-PVM camera sensor has a horizontal viewing angle of 180° and can thus capture so-called “Front Wide Area Image Data”. The fish-eye lens is designed in such a way that, by use of a non-rotationally symmetric free-form surface as its surface, the light from an object is projected onto an image capturing surface that, besides the area lying next to the vehicle, also encompasses areas in front of and to the side of the vehicle.

DE 10 2023 110 607 A1 discloses a camera-monitor system comprising a fish-eye lens, wherein insights into different fields of view are provided by digital panning of a panorama video.

DE 10 2014 018 040 A1 discloses a lateral camera-monitor system, with which, depending on the driving situation, different fields of view around the vehicle can be depicted by driving situation dependent scaling of the depicted image regions.

### SUMMARY OF THE INVENTION

In view of this, an object of the invention provides a camera-monitor system for vehicles, in particular, commercial vehicles and further in particular for commercial vehicles with a large front end structure, such as e.g. conventional cab trucks or vehicles that have equipment mounted in front of them, that enables viewing both the area lying ahead of the vehicle as well as the areas lying to the side of the vehicle and at the same time does not increase the complexity of the camera-monitor system and presents a clear display to the driver.

The invention is based on the idea of creating a camera-monitor system with which, on a display unit inside of the driver cabin, both regions can be depicted and viewed that the driver of the vehicle, in the case of vehicles with a large front end assembly, cannot view by direct sight, because they lie laterally in front of the vehicle, as well as such regions that the driver could view by direct sight. To ensure that both the complexity of the camera-monitor system stays low, and also that a clear image is presented to the driver, the camera-monitor system provides one single camera that is mountable in the front section of the vehicle and that thus lies significantly ahead of the eye-line of the driver. The camera comprises an optic of such a kind that, with it, even though the camera is oriented ahead, i.e. towards the forward direction of travel, areas perpendicular to the vehicle forward direction of travel can be captured. Thus, areas can be captured that could usually only be captured through separate cameras that are oriented in the cross direction, i.e. the direction perpendicular to the vehicle forward direction of travel and that the driver of the vehicle, due to his position being situated further back, relative to the camera position, potentially cannot view, since they e.g. are still hidden from the driver by obstacles such as walls or houses. By using a single, accordingly adapted camera, a continuous, while usually distorted, image of the anterior surroundings of the vehicle and, at the same time, of the sideways surroundings (right and left) in front of the vehicle can be captured and made available to display. This means that the image displayed to the driver of the areas ahead of the vehicle is continuous in the direction perpendicular to the forward direction of travel from left to right and uninterrupted. Both the lateral areas (lateral fields of view) as well as the central area (central field of view) are not only captured by a single camera but also depicted in a common image, resulting in a clear image for the driver.

For this, the camera-monitor system for a commercial vehicle comprises, for the depiction of fields of view in the surroundings of the commercial vehicle, a display unit inside of the driver cabin, a capturing unit with a single camera for capturing image data that comprise a first, and a second, and a third field of view in front of the vehicle, and a processing unit that processes the captured image data to depict on the display unit and that transmits it to the display unit.

The fields of view all lie, with respect to the longitudinal direction of the vehicle, in front of the vehicle. At least a first field of view lies directly ahead of the vehicle, with respect to its lateral extent. A second field of view laterally connects to the first field of view and lies, with relation to its lateral extent, to the side of the vehicle. A third field of view laterally connects to the first field of view and lies, with relation to its lateral extent, to the side of the vehicle on the opposing side to the second field of view.

The fields of view can, in the longitudinal direction of the vehicle (front direction of travel) extend until the horizon, i.e. infinitely, but at a minimum have a extent in the longitudinal direction of the vehicle ahead of the vehicle that surpasses 2 m, and thus lies outside of the immediate vicinity around the vehicle. The second and third field of view can, in the sideways direction relative to the vehicle, also each extend to the until the horizon, respectively, but each have a span in the sideways direction, i.e. perpendicular to the longitudinal direction of the vehicle, that surpasses 2 m. The areas may begin directly at the vehicle, at the anterior edge of the equipment mounted to the vehicle, such as a blade or a shovel, or at a distance, e.g. 1 m, ahead of the anterior edge of the vehicle or the equipment, and extend from there ahead away from the vehicle and feature the desired extent.

The term “in front of” in this description refers to an area that, originating from the frontmost section of the vehicle, extends ahead in the forward direction of travel. “In lateral extension in front of the vehicle” refers to an area that lies in the direction perpendicular to the forward direction of travel, i.e. the lateral direction, at ground level in front of the vehicle, i.e. that the vehicle would pass over upon a continued forward travel. “Laterally in front of” refers to an area that also lies in front of the vehicle but does not include the area that lies in the immediate extension of the vehicle ahead of the vehicle, but that rather, viewed in the forward direction of travel, at ground level connects to the right and left next to the area directly in front of the vehicle.

The vehicle forward direction of travel corresponds to the longitudinal direction of the vehicle towards the front.

Vehicles, for which the camera-monitor system is especially suited, are vehicles with a large front end structure, i.e. where the driver is located significantly behind the frontmost point of the vehicle while operating the vehicle. Usually, these are commercial vehicles such as e.g. commercial trucks with hoods, so-called conventional cab trucks and/or commercial vehicles with large equipment mounted to the front of the vehicle, such as e.g. a blade or a shovel. Preferably, the camera is provided as close as possible to the frontmost point of the vehicle or on equipment mounted to the front of the vehicle.

Preferably, the extent of the first, second, and third field of view is almost infinite in the longitudinal direction of the vehicle, extending until the horizon, at least however, surpasses 10 m. Through this, an image can be displayed that, with regard to its forward extent, nearly corresponds to what the driver sees by direct sight straight ahead out from the vehicle.

Preferably, the extent of the second and third field of view is also infinite in the lateral direction to the vehicle, at least in some sections, i.e. at least for partial areas in the longitudinal direction of the vehicle, but surpasses at least 10 m, preferably at least 100 m. Through this, for example, the cross traffic can be depicted on the displayed image while approaching cross sections and the driver can be shown an image that corresponds to a direct lateral view from the vehicle, as if the vehicle did not have a large front end structure, but rather the driver had his eye-line at the camera position. In particular, in the case of an extent of 100 m or more measured from the center of the vehicle, the camera-monitor system complies with the “Suggestions for camera-monitor systems for vehicles with a restricted field of view, in particular, also due to excessive front end measurements of more than 3.5 m” published in Verkehrsblatt, official section, issue 23, 2016, and is thus suitable as a cross traffic camera system.

The specifications regarding the extent of the fields of view each refer to the case in which the vehicle is located on a horizontal ground plane and are also measured in horizontal direction.

The processing unit processes the image data transmitted from the image sensor to the processing unit using a mapping function f to depict them on the display unit. The image data transmitted from the image sensor to the processing unit can thus correspond to the data captured by the single camera, or be otherwise preprocessed image data, and are thus, before they are transmitted to the display unit for depiction, modified with respect to their location using the mapping function f, e.g. the location in which a point of the image captured by the image sensor is located versus the point in which that point is located in the image to be depicted on the display unit. The mapping function f thus establishes a relation between locations of points P on the two-dimensional Image sensor and the locations of points P′ in the two-dimensional image transmitted to the display unit, such that

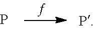

Depending on the selection and embodiment of the mapping function, this, in particular according to a particularly preferred embodiment, serves to depict the lateral fields of view larger in relation to the less relevant front area that could also be viewed by direct sight, or to scale the central field of view relative to the lateral fields of view. Further, depending on the choice of mapping function, through it, the distortions occurring due to the use of the optic of the single camera can be mitigated or at least corrected in part or in partial regions, as needed. Preferably, the use of a mapping function f serves to modify the image, e.g. through scaling of select regions, in such a way that it is as easy as possible for the driver to perceive it, since a large area in front of and to the side of the vehicle is each depicted at an appropriate image size, respectively, all while the image remains a singular, uninterrupted image in the lateral direction relative to the vehicle, in which as much as possible in the areas lying to laterally ahead of the vehicle is perceptible to the driver. Scaling of at least partial regions of the image to be depicted on the display unit versus the image projected onto the image sensor can be achieved by the mapping function f featuring a portion that features a scaling factor in one or more coordinate directions, which in itself is a function of the coordinate in this direction, i.e. is variable along the coordinate direction in which scaling is to occur, depending on that coordinate.

Scaling refers to that regions of the image or the entire image are compressed (for a scaling factor σ for which 0<σ<1 applies) or expanded (for a scaling factor σ for which σ>1 applies) compared to the original image in one or more directions.

A mapping function f, with which a point P on the image sensor is assigned to a point P′ in the image to be depicted on and transmitted to the display unit

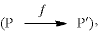

therein refers to a relation, which assigns locations in the image to be transmitted to the display unit to the image data of the two-dimensional image captured by the camera, i.e. the image data on the image sensor, in one or more directions of the image, such that the location of a respective image datum to be depicted on the display unit in this direction of the two-dimensional image is a function of the location of the captured image datum on the image sensor in this direction.

The location of the image data of the image transmitted from the image sensor to the processing unit and/or the location of the image data of the image transmitted from the processing unit to the display unit can therein e.g. be defined as cartesian coordinates, wherein the origin of the cartesian coordinate system lies e.g. in the center of the image sensor or in the center of the image to be transmitted to the display unit, but also in another location. The direction can therein correspond to a cartesian coordinate direction of the two-dimensional image on the image sensor. If one cartesian coordinate system each is assigned to the image sensor as well as the image to be depicted on the display unit, respectively, the mapping function f is, for example, also defined in cartesian coordinates, the following applies:

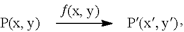

i.e. one point P′(x′, y′) on the image to be depicted on the display unit is assigned to a point P(x, y) on the image sensor using the mapping function f(x, y). The assignment of a point P(x, y) to a point P′(x′, y′) is meant to, beside the distinct assignment of a point P to a point P′, also refer to that multiple points P (a region of the image sensor image) are mapped to a single point P′ (or a smaller region) of the image to be transmitted to the display unit, or vice-versa, that a single point P is mapped to multiple points P′(an image region comprising multiple points).

Alternatively, the location of the image data of the image transmitted from the image sensor and/or the location at which image data is to be depicted on the display unit can e.g. be defined as radially symmetric coordinates and the mapping function can be a radially symmetric function, i.e. a function of the angle and the radius. In this case the following applies:

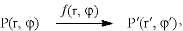

i.e. one point P′(r′, φ′) in the image to the transmitted to the display unit is assigned to one point P(r, p) on the image sensor using the mapping function f(r, φ).

The image data projected onto the image sensor are therein, at a fixed mounting position and orientation of the camera on the vehicle and specific camera type, associated with an unambiguously associated area on the ground level in front of the vehicle, or correspond to it. Thus, corresponds e.g. the area that lies in the lateral direction in front of the vehicle to an in the left-right direction, i.e. x-coordinate direction central region on the image sensor and in the image to be transmitted to the display unit. However, in particular when using cameras with a severely wide angle, the borders of the field of view on the image sensor are not rectilinear, such as on the ground level, but are curved. Thus, image data corresponding to a field of view refer to that the image data for the most part correspond to the field of view, albeit the curved borders of the field of view occurring on the image sensor are not necessarily followed, and at the edges, other fields of view may be included. Nonetheless, the major part of the image data, e.g. more than 95%, preferably more than 98%, further preferably 99% must correspond to the respective field of view. Ideally, however, the curved border of the field-of-view is followed.

Particularly preferably, the mapping function f in one or more coordinate directions comprises a scaling portion, or a scaling component σ, such that e.g. in cartesian coordinates,

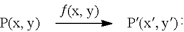

x′=σₓ x, y′=σ_{y} y, applies for all x, y, where σₓ and σ_{y} are scaling factors and can each be constants of functions in this coordinate direction, respectively, e.g. a parabola function σₓ (σₓ=ax²) can be used as a variable scaling factor dependent on x and a constant σ_{y} (σ_{y}=const) can be used as a constant scaling factor along the y-direction. The degree of scaling (scaling factor) is preferably not uniform along at least the coordinate direction in which scaling is to be applied, but comprises a course. The course of the scaling factor can, in the case it is defined in the cartesian coordinate system, in the direction lateral to the vehicle comprise a continuous course, e.g. parabola-shaped, or a course with discontinuities, e.g. by it being defined section-wise. The direction lateral to the vehicle corresponds to the direction perpendicular to the forward direction of travel of the vehicle, i.e. the left-right direction, that is usually depicted as horizontal on a display unit. If the scaling is applied along a coordinate direction of the coordinate system, the same scaling or the same scaling course can be chosen for all values of the other coordinate: If, for example, scaling is applied along the x-direction, this can apply in the same way to all values of y, i.e. the course of the scaling factor along the x-direction is independent of y. Alternatively, the scaling factor can be dependent on the other coordinate, e.g. in the case of a scaling along the x-direction, the scaling course can be a function of x and y.

In the case of a rotationally symmetric coordinate system, the course of the scaling factor can be continuous in the radial direction or it can be a course with discontinuities. Continuous means that the course features no discontinuities. If a continuous course is used, it does not have to be identical across the entire treated region. This results in that, in the direction that is usually also depicted as the left-right direction or radial direction, no discontinuities are present in the depicted image and the image thus, when viewed from left to right, appears as continuous.

Preferably, the course of the scaling factor, as a function defined using cartesian coordinates, comprises two or more partial regions in the direction lateral to the vehicle, in which the course of the scaling factor is defined in different functions, is determined by the same function type with different function parameters, and/or is otherwise different. Thereby, for example, the lateral fields of view can be treated with a different course of the scaling factor than the central field of view. Preferably, the course of the scaling factor is axisymmetric in the partial region that corresponds to the left lateral field of view, axisymmetric with respect to a symmetry axis that runs through the image center of the image to be depicted and preferably contains the projection of the longitudinal vehicle center plane on the ground level, to the course of the scaling factor in the partial region that corresponds to the right lateral field of view. This creates an image in which the lateral fields of view that are non-viewable or poorly viewable by direct sight are depicted as larger relative to the less relevant frontal area that can also be viewed by direct sight, and thus an image that depicts relevant areas well, but still serves the continuous perception of the entire area.

Preferably, the processing unit is adapted to process the image data that corresponds to the first field of view that, in terms of its lateral extension, lies in front of the vehicle, with one of the two or more partial regions of the course of the scaling factor. In this case the mapping function thus also has two or more partial regions that correspond to the partial regions of the course of the scaling factor, one of which is associated with the specific image data and is used for the specific image data that capture the central area lying in front of the vehicle, and that uses the other partial regions are e.g. used for image data that contain the lateral fields of view. In the central field of view lying in front of the vehicle, in a preferred embodiment of the invention, the transformation using the mapping function f, that takes into account the two or more partial regions of the course of the scaling factor, which causes the depicted central field of view to appear scaled versus the central field of view captured on the image sensor. Thereby, the region of the depicted image the depiction of which corresponds to what the driver sees straight ahead by direct sight, can be scaled and the lateral regions are not or poorly visible by direct sight can be depicted enlarged relative to it. A relatively enlarged depiction of the lateral fields of view can be achieved by the central field of view being scaled and the lateral fields of view remaining unchanged, the central field of view being scaled and the lateral fields of view being enlarged, or the central field of view remaining unchanged and the lateral fields being enlarged, each respective of the captured image data on the image sensor. Finally, a relatively enlarged depiction can also be achieved by the central field of view being scaled more in comparison to the lateral fields of view or the central field of view being enlarged less in comparison to the lateral fields of view. If needed, different scaling may also be used.

Preferably, the processing unit is adapted to process the image data that correspond to the second and/or third field of view that, with respect to their lateral extent lie laterally next to the vehicle with one of the two or more partial regions of the course of the scaling factor. In this case, the mapping function f thus also has two or more partial regions the correspond to the partial regions of the course of the scaling factor, one of which is used for those image data that capture an area lying laterally in front of the vehicle, and the other partial regions are e.g. used for image data that contain the field of view lying directly in front of the vehicle. Thereby, the region of the depicted image, the depiction of which corresponds to what the driver would see laterally by direct sight if his vehicle did not have a frontal structure, can the adapted the perception by direct sight.

Preferably, a partial region, if needed a further partial region, of the course of the scaling factor and, thus, of the mapping function f, can be provided for one or multiple transition regions between the first and the second, or third field of view. That means that the processing unit is adapted to process the image data that correspond to a transition region between the first field of view and the second and/or third field of view, with one of the two or more partial regions of the mapping function f. Thereby the transitions in the depicted image are smoothed such that when viewing it, no discontinuities or similar appear in the image, even if e.g. significantly different scaling is used for neighboring regions. A further example for this is to edit those regions that lie in the proximity of a (curved) border of the image data of two neighboring fields of view on the image sensor with their own particularly suitable mapping function that, if needed, comprises further components besides the scaling component. Thereby, in particular, distortions of the image present on the image sensor can be corrected, before these are transmitted to the monitor for depiction.

When using cartesian coordinates, the course of the scaling factor in the longitudinal direction of the vehicle can exhibit a continuous course of a course with discontinuities. The longitudinal direction of the vehicle usually corresponds to a coordinate direction (y-direction) of the depicted, or captured image. A continuous course results in no perceivable discontinuities being discernible in the depicted image in this direction.

Preferably, the single camera of the capturing unit comprises a wide angle lens, in particular, a wide angle lens comprising an angle of 150°. Through a suitable choice of the optic, areas in front of and simultaneously laterally in front of the vehicle can be captured with it, the extent of which corresponds to the desired extent. Especially suitable is therein, if the camera comprises a fish-eye lens.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, embodiments are described by means of the accompanying figures in a purely exemplary manner. The Figures show:

FIG. 1 schematically, a camera-monitor system according to the invention;

FIG. 2 a top-down view onto a vehicle with a front end structure, onto which a camera-monitor system according to FIG. 1 is mounted, as well as, schematically, fields of view to be captured by the camera-monitor system;

FIG. 3a a first example of a course of the scaling factor in a cartesian coordinate system together with the coordinate system of the image sensor;

FIG. 3b a second example of a course of the scaling factor in a cartesian coordinate system;

FIG. 3c a third example of a course of the scaling factor in a cartesian coordinate system;

FIG. 3d a further example for a course of the scaling factor in a cartesian coordinate system;

FIG. 3e another further example for a course of a scaling factor in a cartesian coordinate system;

FIG. 3f an example for a course of the scaling factor in a radially symmetric coordinate system together with the coordinate system of the image sensor;

FIG. 3g a further example for a course of the scaling factor in a radially symmetric coordinate system; and

FIG. 4 an example for an image captured with the camera of the camera-monitor system and of the image transmitted to the display unit after applying the mapping function as well as the course of the scaling factor.

### DETAILED DESCRIPTION OF THE DISCLOSED EMBODIMENTS

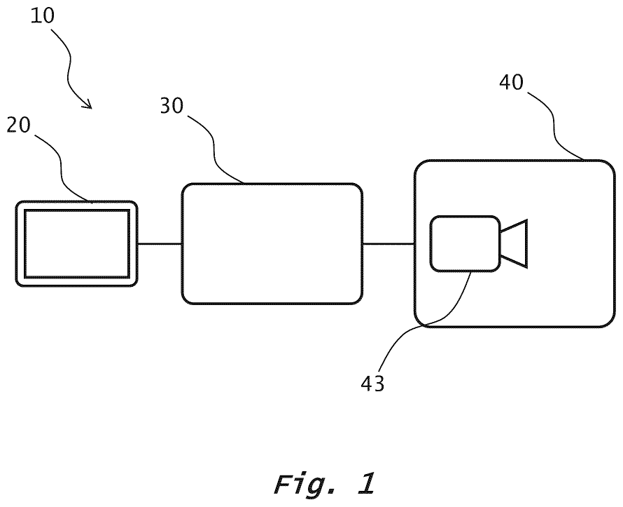

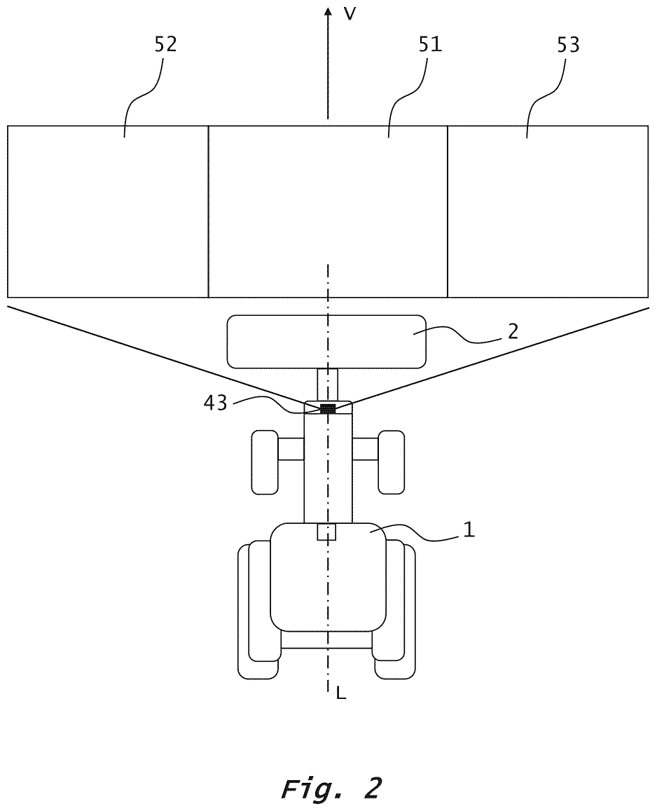

FIG. 1 shows a camera-monitor system 10 that may be used as a cross-traffic vision system on a commercial vehicle 1 shown in FIG. 2 with a front end structure, e.g. a conventional cab truck or a commercial vehicle with equipment 2 mounted to its front, such as e.g. a snow plow vehicle with a plow blade or a tractor with a shovel.

The camera-monitor system 10 comprises a capturing unit 40 that comprises a camera 43 as a recording unit to record image data. In the depicted embodiment, the camera 43 is formed as a wide angle camera with a recording angle of ≥150°, in particular, as a camera 43 with a fish-eye lens. Further, the camera-monitor system 10 comprises a processing unit 30, with which the image data captured with the capturing unit 40 are edited for depicting on the display unit 20. The display unit 20, which, for example, is formed as a monitor or a projector with a projector screen, is arranged in the driver cabin of the vehicle in such a way that a driver can view it during the operation of the vehicle.

The mentioned components of the camera-monitor system 10 may be designed each as singular components separately from each other or can at least be partially integrated. As such, the processing unit 30 may be, for example, integrated with the display unit 20, and/or a part of the capturing unit 40. Further, it is possible that a part of the components are realized via an on-board computer internal to the vehicle.

The image data captured by the camera 43 are transmitted to the processing unit 30 for processing. There, the image data are edited using the mapping function in such a way that the data available after editing and transmitted to the display unit 20 and to by depicted on it deliver an image of the anterior surroundings of the vehicle that is as easy as possible to understand for the driver. The processed image data transmitted to the display unit 20 are then depicted on the display unit 20.

FIG. 2 schematically shows a top-down view (birds-eye view) of a vehicle 1, to which a camera-monitor system 10 according to the invention is mounted. The camera 43 of the camera-monitor system 10 is provided in a frontmost area of the vehicle 1, in the depicted embodiment, however, behind equipment 2 mountable to the vehicle. In particular, the camera 43 is mounted at a central position in the proximity of the vehicle center plane (plane perpendicular to the ground level on the which the vehicle stands, that extends along the longitudinal direction of the vehicle L and which contains the center of the vehicle in the lateral direction) direction forward on the vehicle 1 or its front end structure. This means, since the vehicle 1 comprises a significant front end structure ahead of the location which a driver assumes during the operation of the vehicle 1, that the camera 43 is located in the vehicle forward direction of travel V (implied using an arrow in FIG. 2) significantly ahead of the eye-line of the driver and, thus, can view lateral areas that lie further ahead than what the driver can see by direct sight.

Further, in FIG. 2, the fields of view 51, 52, 53 that are to be captured by the camera 43 of the camera-monitor system 10, are drawn as areas. The fields of view 51, 52, 53 each lie ahead of the anterior end on the vehicle 1 and may directly (in the longitudinal direction of the vehicle L) adjoin the vehicle 1 towards the front or a distance between the anterior end of the vehicle 1, or the equipment mounted to it, and the beginning of the fields of view 51, 52, 53 may be provided, as shown in FIG. 2. In each case, the fields of view 51, 52, 53 comprise surrounding areas, that lie at least 2 m ahead of the vehicle, when viewed in the forward direction of travel V of the vehicle.

The first field of view 51 lies centrally in front of the vehicle 1, i.e. its left and right edge, i.e. its edges in the direction perpendicular to the projection of the vehicle center plane onto the ground plane (corresponding to the projection of the longitudinal direction of the vehicle L on the ground plane), each correspond to the forward continuation of the side edges of the vehicle, respectively. In the longitudinal direction of the vehicle L, the field of view 51 can extend until the horizon, i.e. correspond to what the driver sees by direct sight forwards out of the vehicle.

The second field of view 52 lies laterally left in front of the vehicle 1, i.e. its right edge corresponds to the left edge of the first field of view 51 in the direction perpendicular to the longitudinal direction of the vehicle L on the ground plane. The extent of the second field of view 52 forward, i.e. in the longitudinal direction of the vehicle L, may also be until the horizon, but is at least 2 m in front of the frontmost end of the vehicle 1. In the lateral direction to the left, the second field of view 52 may also extend until the horizon, which would correspond to what the driver were to see in the lateral direction by direct sight in the lateral direction if his direction was the one of the camera 43. At least, however, the extent is 2 m in the lateral direction, preferably at least 10 m, further preferably at least 100 m.

The third field of view 53 lies laterally right in front of the vehicle 1, i.e. its left edge corresponds to the right edge of the first field of view 51 in the direction perpendicular to the longitudinal direction of the vehicle L on the ground plane. The extent of the third field of view 53 forward, i.e. in the longitudinal direction of the vehicle L, may also be until the horizon, but is at least 2 m in front of the frontmost end of the vehicle 1. In the lateral direction to the right, the third field of view 53 may also extend until the horizon, which would correspond to what the driver were to see in the lateral direction by direct sight in the lateral direction if his direction was the one of the camera 43. At least, however, the extent is 2 m in the lateral direction, preferably at least 10 m, further preferably at least 100 m.

The second field of view 52 and the third field of view 53 are axisymmetric to an axis of symmetry that corresponds to the projection of the vehicle center plane (longitudinal axis of the vehicle L) onto the ground plane.

The fields of view 51, 52, 53 depicted in FIG. 2 that are schematically drawn two-dimensionally on the ground plane on which the vehicle stands, extend as three-dimensional areas in the surroundings of the vehicle, i.e. they extend in a direction perpendicular to the ground plane upwards.

The camera 43 is adapted to capture the first, second and third field of view 51, 52, 53, i.e. with a single camera, the first, second and third field of view 51, 52, 53 are captured. The first, second, and third field of view 51, 52, 53 are depicted jointly and continuously on the display unit 20.

The image data of the image sensor captured and, if needed, pre-processed by the camera 43 are edited using a mapping function f before they are delivered to the display unit for depiction. The mapping function assigns locations of points P on the image sensor 44 to locations of points P′ on the image to be transmitted to and depicted on display unit 20.

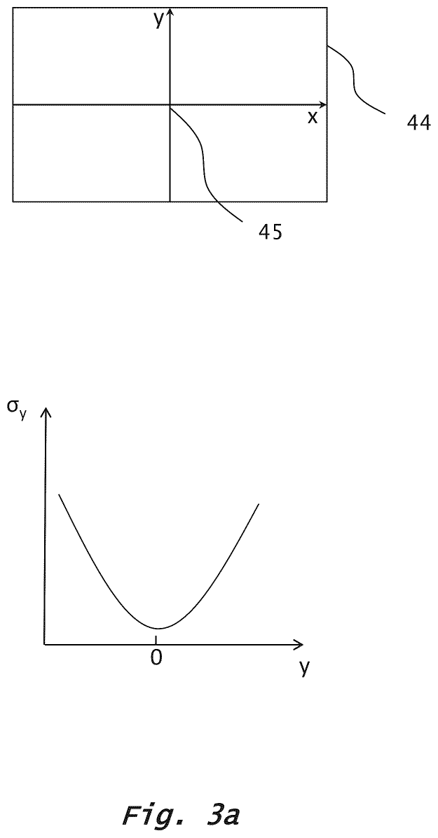

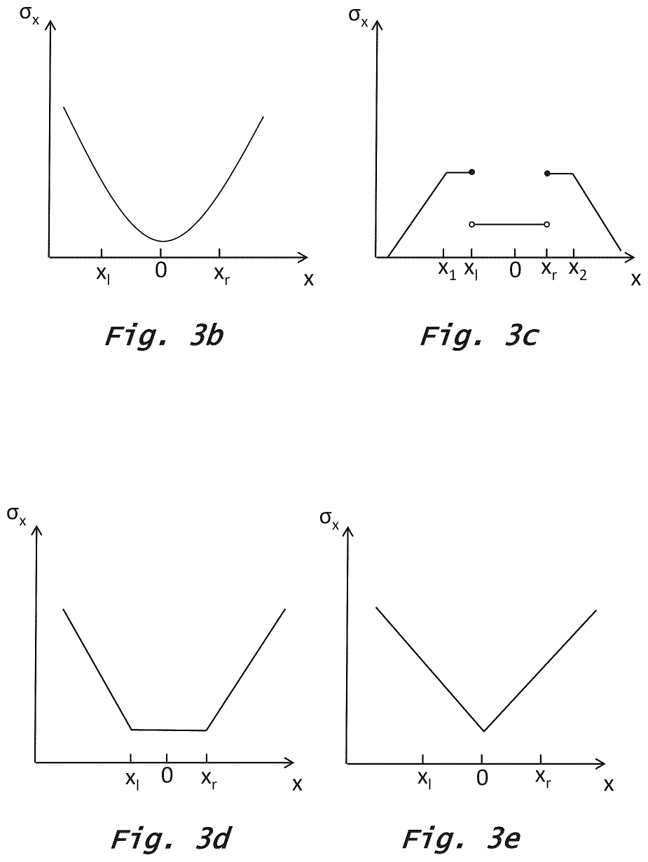

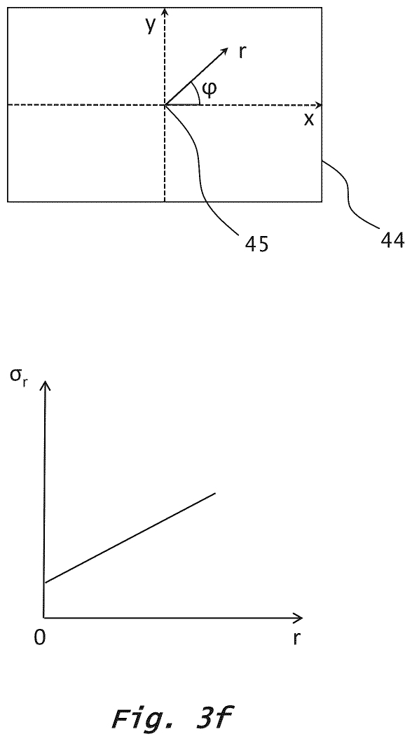

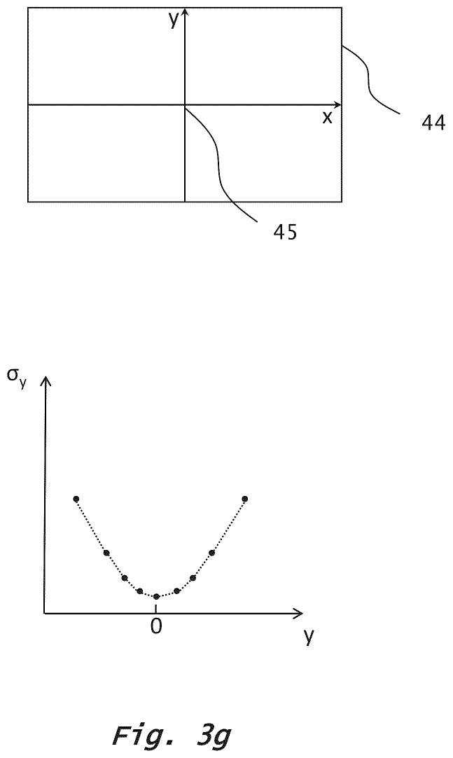

FIG. 3a schematically shows an image sensor 44 to which a coordinate system (x, y) is assigned, the origin 45 of which lies in the center of the image sensor 44. The origin 45 can also be defined in another location. Points P(x, y) on the image sensor are assigned to points P′(x′, y′) on the image (not shown in FIG. 3a) to be transmitted to the display unit 20 using the mapping function f(x, y).

In the embodiments depicted in FIGS. 3a to 3e, the mapping function f(x, y) comprises a scaling component a in one or more coordinate direction, that causes points P(x, y) on the image sensor to be assigned to points P′(x′,y′) in the image transmitted to the display unit, such that image consecutively displayed on the display unit 20 is scaled at least in this coordinate direction at least regionally. For the mapping function f(x′, y′), the following applies:

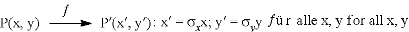

The scaling component a thus generally has a scaling factor σₓ along the x-axis direction and a scaling factor σ_{y} along the y-axis direction. One of the scaling factors σₓ and σ_{y} may be constant, and the other of the scaling factors may comprise a course along the coordinate direction dependent on the coordinate of the coordinate direction.

In FIG. 3a, the course of a scaling factor σ_{y}=f(y) is depicted which, through the mapping y′=σ_{y}y, leads to a scaling course of the depicted image along the y′-coordinate direction. The scaling factor σ_{y} in the embodiment shown in FIG. 3a is a function of y exclusively, i.e. is identical for any value of x at a given value of y. In particular, the course of the scaling factor σ_{y} is a parabolic function σₓ=a y²+b. It is also contemplated that the scaling factor σ_{y} that leads to scaling along the y-direction additionally varies dependent on x, i.e. σ_{y}=f(x, y). In the embodiment depicted in FIG. 3a the scaling factor σₓ that leads to a scaling factor of the image to be depicted along the x-axis is constant, i.e. a comparatively enlarged scaling of partial regions of the image to be depicted along the x′-direction does not occur.

Further examples of courses of scaling factors, depicted in cartesian coordinate systems, are described in the context of FIGS. 3b to 3e, and FIG. 3g.

FIGS. 3b to 3e show examples of courses of scaling factors σₓ=f(x) that, through the mapping x′=σₓx, lead to a scaling course of the image to be depicted on the display unit 20 along the x′ coordinate direction. The scaling factor σₓ in the embodiment shown in FIGS. 3b to 3e is a function of x exclusively, i.e. is identical for any value of y at a given value of x. It is also contemplated that the scaling factor σₓ that leads to scaling along the x-direction additionally varies dependent on y, i.e. σₓ=f(x, y). In the embodiment depicted in FIGS. 3b to 3e, the scaling factor σ_{y} that leads to a scaling factor of the image to be depicted along the y-axis is constant, i.e. a comparatively enlarged scaling of partial regions of the image to be depicted on the display unit 20 along the y′-direction does not occur.

In particular, the course of the scaling factor σₓ depicted in FIG. 3b is a parabolic function: σₓ=a x²+b. The x-coordinate values xₗ and xᵣ drawn in the FIGS. 3b to 3e approximately correspond to the left and the right border of the central field of view 51, inside of which a comparatively large scaling of the image to be depicted versus the lateral fields of view to its left and right (i.e. x<xₗ, and x>xᵣ) thus occurs.

FIG. 3c shows a region-wise course of a scaling factor: In the region x<x₁, the scaling factor increases with the progressive x-component, i.e. from a left image border to a location in which x=x₁. For x₁<x<xₗ, scaling remains constant. In the region xₗ<x<xᵣ, it is also constant, where the scaling factor σₓ, however, is significantly smaller than in the region x<x₁, such that at xₗ, the course of the scaling factor σₓ comprises a discontinuity. The course of the scaling factor σₓ is axisymmetric to the origin of the coordinate system titled 0, i.e. at xᵣ, the course of the scaling factor σₓ comprises a further discontinuity and in the region xᵣ<x is symmetric to the course at x<xₗ.

The course of the scaling factor σₓ shown in FIG. 3d is similar to the one shown in FIG. 3a, wherein in the region x<xₗ and in the region xᵣ<x, the course is a descending and ascending straight, respectively, and in the region xₗ<x<xᵣ, the scaling factor σₓ is constant.

Finally, FIG. 3e shows a course of a scaling factor σₓ that is like the course shown in FIG. 3d, but without the constant region for xₗ<x<xᵣ.

In the embodiment shown in FIG. 3f, the mapping function f(r, φ) also comprises a scaling component a in one or more coordinate directions, that causes points P(r, φ) on the image sensor to be assigned to points P′(r′, φ′) in the image to be transmitted to the display unit 20, such that the depicted image is being scaled in at least this coordinate direction at least regionally. For the mapping function f(r, φ), the following applies:

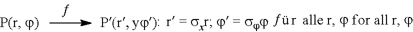

The scaling component a thus generally has a scaling factor σᵣ along the r-coordinate direction and a scaling factor σ_{φ} along the φ angle direction. One of the scaling factors φᵣ and σ_{φ} may be constant, and the other of the scaling factors may comprise a course dependent on the coordinate of the coordinate direction.

In FIG. 3f, the course of a scaling factor σᵣ=f(r) is depicted which, through the mapping r′=σᵣr, leads to a scaling course of the depicted image along the r′-coordinate direction. The scaling factor σᵣ in the embodiment shown in FIG. 3f is a function of r exclusively, i.e. is identical for any value of φ at a given value of r. In the embodiment depicted in FIG. 3f, the scaling factor σ_{φ} that leads to a scaling factor of the image to be depicted along the φ angle direction is constant, i.e. a comparatively enlarged scaling of partial regions of the image to be depicted along the φ-direction does not occur.

The processing using the mapping function, in particular, if it comprises a scaling component, serves to ensure appropriate object sizes in the monitor display and a better visibility of the relevant regions, in particular, to accomplish an improved visibility of the regions that are not well or not at all visible by direct sight, e.g. because they have yet been obscured to the driver. Thus, the depicted images are well interpretable to the driver and the situation in the surroundings of the vehicle are thus easy to put into context. In particular, this is caused by a scaling component of in the mapping function. Beside the processing using the mapping function with a scaling component, the mapping function may contain further components, such as, for example, components for a reduction of the distortion or alike. Further, the image data can also be subject to further processing, such as, for example, a filtering to reduce noise in the image data and/or brightness adjustments or alike, that do not necessarily influence the location of a point to be depicted, but on its other properties, such as e.g. brightness etc.

In FIG. 3g, a course of a scaling factor σ_{y}=f(y) similar to the one depicted in FIG. 3a is shown that causes a scaling course of the depicted image along the y′-coordinate direction through the mapping y′=σ_{y}y. The scaling factor σ_{y} in the embodiment shown in FIG. 3g is a function of y exclusively, i.e. is identical for any value of x at a given value of y. In particular, the course of the scaling factor σ_{y} is a parabolic function σ_{y}=a y²+b. Other than in the case of the course shown in FIG. 3a, only individual support points of the scaling factor σ_{y} are computed, while the course in between the support points of the scaling factor σ_{y} is determined by interpolation, e.g. linear interpolation.

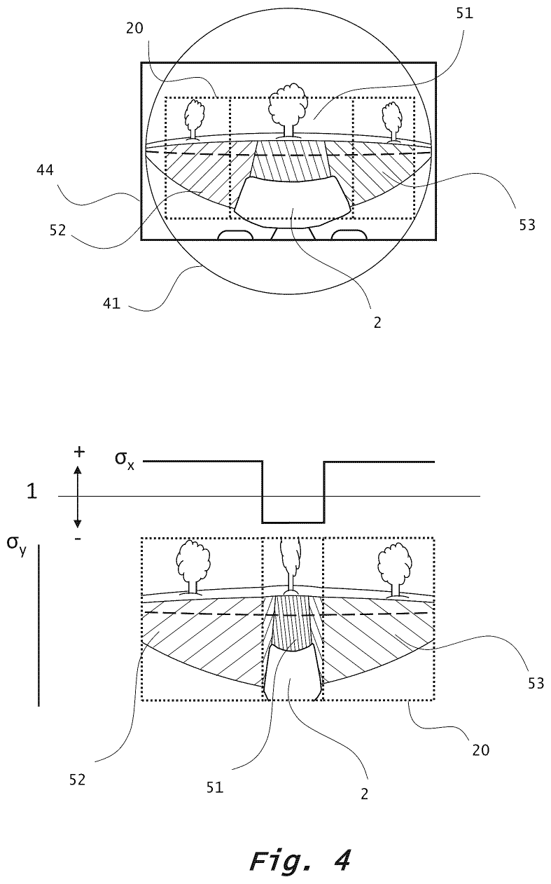

FIG. 4 shows an image, as it is captured by the camera 43 and an image after editing as it is to be depicted on the display unit 20. Further, the course of the scaling factor σₓ that, in the depicted embodiment is a function of x, is depicted. Using the camera 43, the depiction area 41 of the capture unit is captured and stored on an image sensor 44 in the form of image data. Besides the fields of view 51, 52, 53, there is also a piece of equipment 2 visible in the image data which is provided on the vehicle 1. A partial region of the captured image data is edited using the mapping function to produce the image data to be depicted on the display unit 20. For this, in particular in the depicted embodiment, the in the lateral direction central region of the image sensor data that correspond to the field of view 51 lying in front of the vehicle, is scaled in relation to the lateral regions that correspond to the lateral fields of view 52, 53, since the mapping function comprises a scaling component, in particular, a scaling factor σₓ. In this central region, the scaling factor is σₓ<1, such that a compression of the image occurs. In the lateral regions, the scaling factor σₓ is, in the depicted embodiment in such a way that an expansion of the image occurs, i.e. σₓ>1. Alternatively (not depicted), in one of the partial regions (central partial region, lateral partial regions), no scaling could occur, i.e. for the scaling factor in this partial region σₓ=1 applies, since a relative scaling occurs through scaling of the other partial region. By scaling using the mapping function with a scaling component, an image that is simple to grasp to the observer is formed, in which essential information is well discernible both in the lateral areas as well as in the areas lying directly in front of the vehicle.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A camera-monitor system for a commercial vehicle to depict fields of view in the surroundings of the commercial vehicle, wherein the fields of view with respect to the longitudinal direction of the vehicle lie in front of the vehicle comprise at least a first field of view that, with respect to its lateral extent lies in front of the vehicle, a second field of view that laterally adjoins the first field of view and, with respect to its lateral extent lies lateral to the vehicle, and a third field of view that laterally adjoins the first field of view and, with respect to its lateral extent lies laterally to the vehicle on the opposing side of the second field of view,
wherein the camera-monitor system comprises:
a display unit in the driver cabin;
a capturing unit comprising a single camera to capture image data comprising the first, the second, and the third field of view in front of the vehicle,
a processing unit that processes the captured image data to depict them on the display unit and transmits them to the display unit to display them, wherein the first, second and third field of view have an extent in the longitudinal direction of the vehicle that exceeds 2 m, and
wherein the second and the third field of view each have an extent in lateral direction relative to the vehicle that exceeds 2 m,
wherein the processing unit processes the captured image data using a mapping function to depict them on the display unit, wherein the mapping function comprises a scaling component σ.

2. The camera-monitor system according to claim 1, wherein the extent of the first, second, and third field of view in the longitudinal direction in front of the vehicle exceeds 10 m.

3. The camera-monitor system according to claim 1, wherein the extent of the second and third fields of view in direction lateral to the vehicle exceeds 10 m.

4. The camera-monitor system according to claim 1, wherein the mapping function in the direction lateral to the vehicle comprises two or more partial regions in which the mapping function comprises scaling factors, the courses of which are different functions, are the same type of function with different values of function parameters, and/or the course of which is different in another way.

5. The camera-monitor system according to claim 4, wherein the processing unit is adapted to process the image data that correspond to the first field of view that, with respect to its lateral extent lies in front of the vehicle with one of the two or more partial regions of the mapping function.

6. The camera-monitor system according to claim 1, wherein the processing unit is adapted to process the image data corresponding to the second and/or third field of view that, with respect to their lateral extent lie laterally ahead of the vehicle, with one of the two or more partial regions of the mapping function.

7. The camera-monitor system according to claim 1, wherein the processing unit is adapted to process the image data corresponding to a transition region in between the first field of view and the second and/or third field of view with one of the two or more partial regions of the mapping function.

8. The camera-monitor system according claim 1, wherein the mapping function f(x, y) is a function defined in a cartesian coordinate system, wherein the y-direction generally corresponds to the longitudinal direction of the vehicle on the image sensor and in the image to be depicted on the display unit, and the x-direction corresponds to direction lateral to the vehicle on the image sensor and in the image to be depicted on the display unit.

9. The camera-monitor system according to claim 1, wherein the mapping function f(r, φ) is a function defined in a radially symmetric coordinate system, the origin of which is central to the image sensor and/or the image to be depicted on the display unit.

10. The camera-monitor system according to claim 1, wherein the camera of the capturing unit comprises a wide angle lens.

11. The camera-monitor system according to claim 10, wherein the camera comprises a fish-eye lens.

12. The camera-monitor system according to claim 2, wherein the extent of the second and third fields of view in direction lateral to the vehicle exceeds 100 m.

13. The camera-monitor system according to claim 2, wherein the mapping function in the direction lateral to the vehicle comprises two or more partial regions in which the mapping function comprises scaling factors, the courses of which are different functions, are the same type of function with different values of function parameters, and/or the course of which is different in another way.

14. The camera-monitor system according to claim 2, wherein the processing unit is adapted to process the image data corresponding to the second and/or third field of view that, with respect to their lateral extent lie laterally ahead of the vehicle, with one of the two or more partial regions of the mapping function.

15. The camera-monitor system according to claim 1, wherein the camera of the capturing unit comprises a wide angle lens comprising an angle of ≥150°.
